(19) United States
(12) Patent Application Publication
(10) Pub. No.: US 2024/0426961 A1
(43) Pub. Date: Dec. 26, 2024

(54) Parallel Connected Inverters

(71) Applicant: Solaredge Technologies Ltd., Herzeliya (IL)

(72) Inventors: Meir Adest, Modiin (IL); Guy Sella, Bitan Aharon (IL); Lior Handelsman, Givatayim (IL); Yoav Galin, Raanana (IL); Amir Fishelov, Tel Aviv (IL); Meir Gazit, Ashkelon (IL); Tzachi Glovinsky, Petah Tikva (IL); Yaron Binder, Shoham (IL)

(21) Appl. No.: 18/754,718

(22) Filed: Jun. 26, 2024

Related U.S. Application Data
(63) Continuation of application No. 18/317,243, filed on May 15, 2023, now Pat. No. 12,055,647.
Application No. 18/317,243 is a continuation of application No. 17/520,982, filed on Nov. 8, 2021, now Pat. No. 11,693,080.
Application No. 17/520,982 is a continuation of application No. 16/830,804, filed on Mar. 26, 2020, now Pat. No. 11,183,923.
Application No. 16/830,804 is a continuation of application No. 15/958,129, filed on Apr. 20, 2018, now Pat. No. 10,644,589.
Application No. 15/958,129 is a continuation of application No. 15/184,040, filed on Jun. 16, 2016, now Pat. No. 9,979,280.
Application No. 15/184,040 is a continuation of application No. 14/071,780, filed on Nov. 5, 2013, now Pat. No. 9,407,161.
Application No. 14/071,780 is a continuation of application No. 13/596,308, filed on Aug. 28, 2012, now Pat. No. 8,599,588.
Application No. 13/596,308 is a continuation of application No. 12/329,520, filed on Dec. 5, 2008, now Pat. No. 8,289,742.
(60) Provisional application No. 60/992,589, filed on Dec. 5, 2007.

(51) Int. Cl. G01S 3/786; H02J 3/38; H02J 3/46; H02J 13/00; H02M 1/00; H02M 1/08; H02M 1/44; H02M 3/04; H02M 7/44; H02M 7/493; H02S 40/22

(52) U.S. Cl. CPC G01S 3/7861; H02J 3/38; H02J 3/46; H02J 13/00; H02M 1/08; H02M 1/44; H02M 3/04; H02M 7/44; H02M 7/493; H02S 40/22; H02J 3/381; H02J 3/388; H02J 2300/26; H02M 1/0009; H02M 1/0077; Y02E 10/52; Y02E 10/56

(57) ABSTRACT

A distributed power system wherein a plurality of power converters are connected in parallel and share the power conversion load according to a prescribed function, but each power converter autonomously determines its share of power conversion. Each power converter operates according to its own power conversion formula/function, such that overall the parallel-connected converters share the power conversion load in a predetermined manner.

### CROSS-REFERENCE TO RELATED APPLICATIONS

The present application is a continuation of U.S. application Ser. No. 18/317,243, filed May 15, 2023, which is a continuation of U.S. application Ser. No. 17/520,982, filed Nov. 8, 2021 (now U.S. Pat. No. 11,693,080), which is a continuation of U.S. application Ser. No. 16/830,804, filed on Mar. 26, 2020 (now U.S. Pat. No. 11,183,923), which is a continuation of U.S. application Ser. No. 15/958,129, filed on Apr. 20, 2018 (now U.S. Pat. No. 10,644,589), which is a continuation of U.S. application Ser. No. 15/184,040, filed on Jun. 16, 2016 (now U.S. Pat. No. 9,979,280), which was a continuation of U.S. application Ser. No. 14/071,780, filed Nov. 5, 2013 (now U.S. Pat. No. 9,407,161), which is a continuation of U.S. application Ser. No. 13/596,308, filed Aug. 28, 2012 (now U.S. Pat. No. 8,599,588), which is a continuation application of U.S. application Ser. No. 12/329,520, filed Dec. 5, 2008 (now U.S. Pat. No. 8,289,742), which claims priority benefit from U.S. Application Ser. No. 60/992,589, filed Dec. 5, 2007. The disclosures of each of the above applications are incorporated herein by reference in their entirety.

### TECHNICAL FIELD

The present invention relates to distributed power systems and, more particularly, a system and method for sharing power inversion/conversion between parallel connected power inverters/converters connected to the distributed power system.

### DESCRIPTION OF RELATED ART

A conventional installation of a solar distributed power system 10, including multiple solar panels 101, is illustrated in FIG. 1. Since the voltage provided by each individual solar panel 101 is low, several panels 101 are connected in series to form a string 103 of panels 101. For a large installation, when higher current is required, several strings 103 may be connected in parallel to form overall system 10. The interconnected solar panels 101 are mounted outdoors, and connected to a maximum power point tracking (MPPT) module 107 and then to an inverter 104. MPPT 107 is typically implemented as part of inverter 104 as shown in FIG. 1. The harvested power from DC sources 101 is delivered to inverter 104, which converts the direct-current (DC) into alternating-current (AC) having a desired voltage and frequency, which is usually 110V or 220V at 60 Hz, or 220V at 50 Hz. The AC current from inverter 104 may then be used for operating electric appliances or fed to the power grid.

As noted above, each solar panel 101 supplies relatively very low voltage and current. A problem facing the solar array designer is to produce a standard AC current at 120V or 220V root-mean-square (RMS) from a combination of the low voltages of the solar panels. The delivery of high power from a low voltage requires very high currents, which cause large conduction losses on the order of the second power of the current i². Furthermore, a power inverter, such as inverter 104, which is used to convert DC current to AC current, is most efficient when its input voltage is slightly higher than its output RMS voltage multiplied by the square root of 2. Hence, in many applications, the power sources, such as solar panels 101, are combined in order to reach the correct voltage or current. A large number of panels 101 are connected into a string 103 and strings 103 are connected in parallel to power inverter 104. Panels 101 are connected in series in order to reach the minimal voltage required for inverter 104. Multiple strings 103 are connected in parallel into an array to supply higher current, so as to enable higher power output.

FIG. 1B illustrates one serial string 103 of DC sources, e.g., solar panels 101a-101d, connected to MPPT circuit 107 and inverter 104. The current (ordinate) versus voltage (abscissa) or IV characteristics are plotted (110a-110d) to the left of each DC source 101. For each DC power source 101, the current decreases as the output voltage increases. At some voltage value, the current goes to zero, and in some applications the voltage value may assume a negative value, meaning that the source becomes a sink. Bypass diodes (not shown) are used to prevent the source from becoming a sink. The power output of each source 101, which is equal to the product of current and voltage (P=i*V), varies depending on the voltage drawn from the source. At a certain current and voltage, close to the falling off point of the current, the power reaches its maximum. It is desirable to operate a power generating cell at this maximum power point (MPP). The purpose of the MPPT is to find this point and operate the system at this point so as to draw the maximum power from the sources.

In a typical, conventional solar panel array, different algorithms and techniques are used to optimize the integrated power output of system 10 using MPPT module 107. MPPT module 107 receives the current extracted from all of solar panels 101 together and tracks the maximum power point for this current to provide the maximum average power such that if more current is extracted, the average voltage from the panels starts to drop, thus lowering the harvested power. MPPT module 107 maintains a current that yields the maximum average power from system 10.

However, since power sources 101a-101d are connected in series to single MPPT 107, MPPT 107 selects a maximum power point which is some average of the maximum power points of the individual serially connected sources 101. In practice, it is very likely that MPPT 107 would operate at an 1-V point that is optimum for only a few or none of sources 101. In the example of FIG. 1B, the selected point is the maximum power point for source 101b, but is off the maximum power point for sources 101a, 101c and 101d. Consequently, the arrangement is not operated at best achievable efficiency.

The present applicant has disclosed in co-pending U.S. application Ser. No. 11/950,271 entitled “Distributed Power Harvesting Systems Using DC Power Sources”, the use of an electrical power converter, e.g. DC-to-DC converter, attached to the output of each power source, e.g. photovoltaic panel. The electrical power converter converts input power to output power by monitoring and controlling the input power at a maximum power level.

### SUMMARY

The following summary of the invention is included in order to provide a basic understanding of some aspects and features of the invention. This summary is not an extensive overview of the invention and as such it is not intended to particularly identify key or critical elements of the invention or to delineate the scope of the invention. Its sole purpose is to present some concepts of the invention in a simplified form as a prelude to the more detailed description that is presented below.

Aspects of the invention provide load balancing of a parallel connected power converter, wherein each converter autonomously determines its own power conversion load.

According to an embodiment of the present invention there is provided a distributed power system including a direct current (DC) power source and multiple inverters. The inverter inputs are adapted for connection in parallel to the DC power source. The inverter outputs adapted for connection in parallel. Multiple control modules connect respectively to the inverters' inputs. The control modules respectively control current drawn by the inverters from the DC input responsive to either the voltage or power of the DC input so that a voltage or power equilibrium, i.e., specified draw, is reached in the DC input. That is, the control module continuously monitors the power provided by the DC power source and adjust the current or power conversion of the power converter according to a specified function. Consequently, the inverters share the load of inverting power from the DC power source to output power. A power module may be attached between the DC power source and the inverters and include an input coupled to said DC power source and an output to the inverter inputs. The power module may be configured to maintain maximum peak power at the input coupled to the DC power source or the power module may be configured to control at maximum peak power at its output. Alternatively, a single maximum peak power tracking module connects the DC power source to the control modules. The control modules include a voltage loop block which upon comparing the voltage of the serial string to a previously specified reference voltage, outputs a current reference signal based on the comparison. A current loop block compares the current reference signal with a current signal proportional to the current in the DC power source.

According to embodiments of the present invention there is provided a method for sharing load in a distributed power system. Multiple inverters are coupled in parallel to the DC power source. The inverters invert power from the DC power source to an output power.

Current drawn by the inverters from the DC power source is autonomously controlled by each inverter responsive to selectably either the voltage or power of the DC input. In this manner, the inverters share the load of the inverting power from the DC power source to the output power according to a prescribed power conversion sharing function. A power module disposed between the DC power source and the inverters includes an input coupled to the DC power source and an output to inputs of the inverters. The power module optionally maintains maximum peak power at the input coupled to the DC power source.

According to another embodiment of the present invention there is provided a distributed power system including a direct current (DC) power source and multiple power converters. The power converter inputs are adapted for connection in parallel to the DC power source. The power converter outputs are adapted for connection in parallel. Multiple control modules connect respectively to the power converter's inputs. The control modules respectively control current drawn by the power converters from the DC input responsive to either the voltage or power of the DC input until either a voltage or power equilibrium is reached in the DC input. The power converters share the load of inverting power from the DC power source to output power.

According to embodiments of the present invention there is provided a method for sharing load in a distributed power system. Current drawn from a DC input by the inverters is individually controlled by each inverter responsive to the DC input. An equilibrium is reached in the DC input for each given DC power input, such that DC power conversion is shared among the inverters according to a prescribed formula. The inverter autonomously draws a portion of the load of inverting power from the DC input to output power.

The foregoing and/or other aspects will become apparent from the following detailed description when considered in conjunction with the accompanying drawing figures.

### BRIEF DESCRIPTION OF THE DRAWINGS

The accompanying drawings, which are incorporated in and constitute a part of this specification, exemplify embodiments of the present invention and, together with the description, serve to explain and illustrate principles of the invention. The drawings are intended to illustrate various features of the illustrated embodiments in a diagrammatic manner. The drawings are not intended to depict every feature of actual embodiments nor relative dimensions of the depicted elements, and are not necessarily drawn to scale.

The invention is herein described, by way of example only, with reference to the accompanying drawings, wherein:

FIGS. 1 and 1B are block diagram of conventional power harvesting systems using photovoltaic panels as DC power sources;

FIG. 2 illustrates a distributed power harvesting circuit, based on the disclosure of U.S. application Ser. No. 11/950,271;

FIG. 3 illustrates a simplified system, according to an embodiment of the present invention;

FIG. 4, is a simplified flow diagram of a method, illustrating a feature of the present invention;

FIG. 5 illustrates a simplified system, according to another embodiment of the present invention;

FIG. 6 which illustrates details of a control module integrated inside an inverter, in accordance with different embodiments of the present invention;

FIG. 7 is a graph showing a typical control current-voltage characteristic for controlling current response to input voltage, according to a feature of the present invention; and

FIGS. 8A and 8B which illustrate racks and connections to the racks with parallel connected inverters, according to a feature of the present invention.

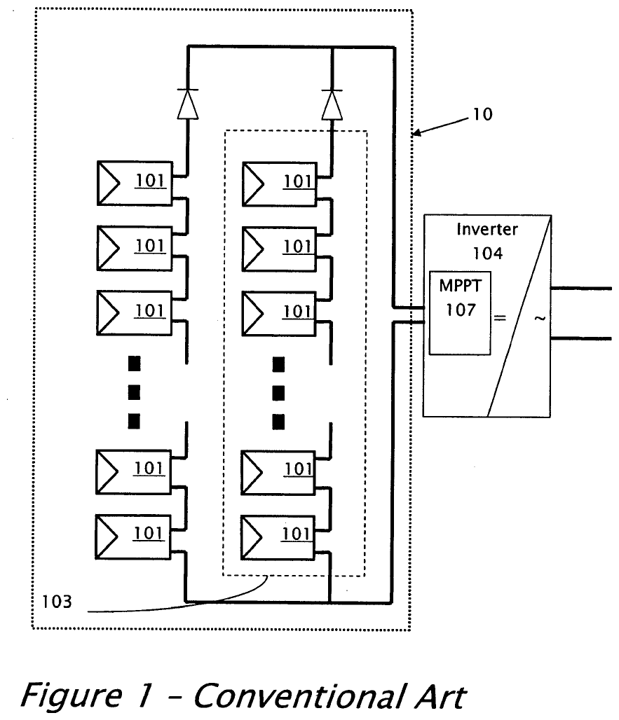

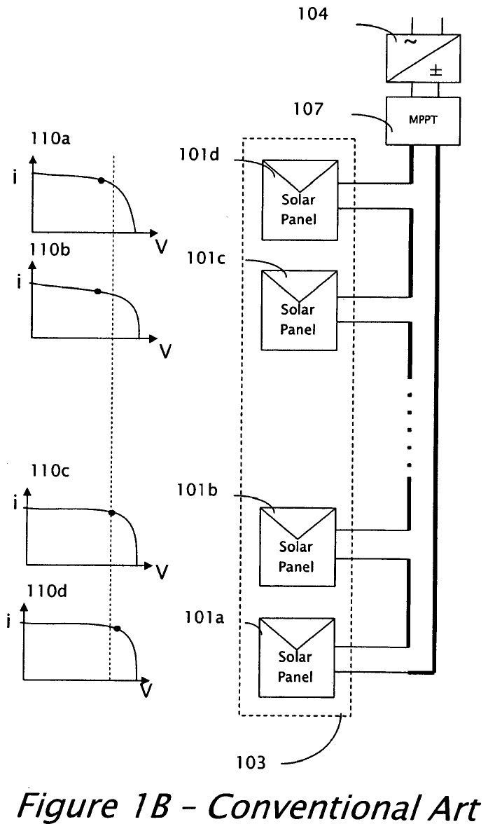

### DETAILED DESCRIPTION

Reference will now be made in detail to embodiments of the present invention, examples of which are illustrated in the accompanying drawings, wherein like reference numerals refer to the like elements throughout. The embodiments are described below to explain the present invention by referring to the figures.

It should be noted, that although the discussion herein relates primarily to photovoltaic systems and more particularly to those systems previously disclosed in U.S. application Ser. No. 11/950,271, the present invention may, by non-limiting example, alternatively be configured as well using conventional photovoltaic distributed power systems and other distributed power systems including (but not limited to) wind turbines, hydroturbines, fuel cells, storage systems such as battery, super-conducting flywheel, and capacitors, and mechanical devices including conventional and variable speed diesel engines, Stirling engines, gas turbines, and micro-turbines.

By way of introduction, distributed power installations have inverters which invert DC power to AC power. In large scale installations, a large inverter may be used, but a large inverter is more difficult to maintain and repair, leading to long downtime. The use of a number of small inverters has a benefit of modularity. If one inverter constantly is operating and a second inverter begins to operate when there is a larger load to handle, there is more wear on the working inverter. Hence load balancing between the inverters is desired. If the control of the two inverters is through a master/slave technique there is an issue of a single point of failure. The single master may break down and take the rest of the system out of whack. A good solution would be a load-balancing, not master-slave driver modular inverter. This disclosure shows a system and method for doing so. To be sure, in the context of this disclosure, load balancing does not necessarily mean that the load is spread among the converters in equal amounts, but rather that the load is distributed among the converters such that each converter assumes a certain part of the load, which may be predetermined or determined during run time.

It should be noted, that although the discussion herein relates primarily to grid tied power distribution systems and consequent application to inversion (i.e. power conversion from direct current (DC) to alternating current (AC), the teachings of the present invention are equally applicable to DC-DC power conversion systems such as are applicable in battery storage/fuel cell systems. Hence the terms “inverter” and “converter” in the present context represent different equivalent embodiments of the present invention.

Before explaining embodiments of the invention in detail, it is to be understood that the invention is not limited in its application to the details of design and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

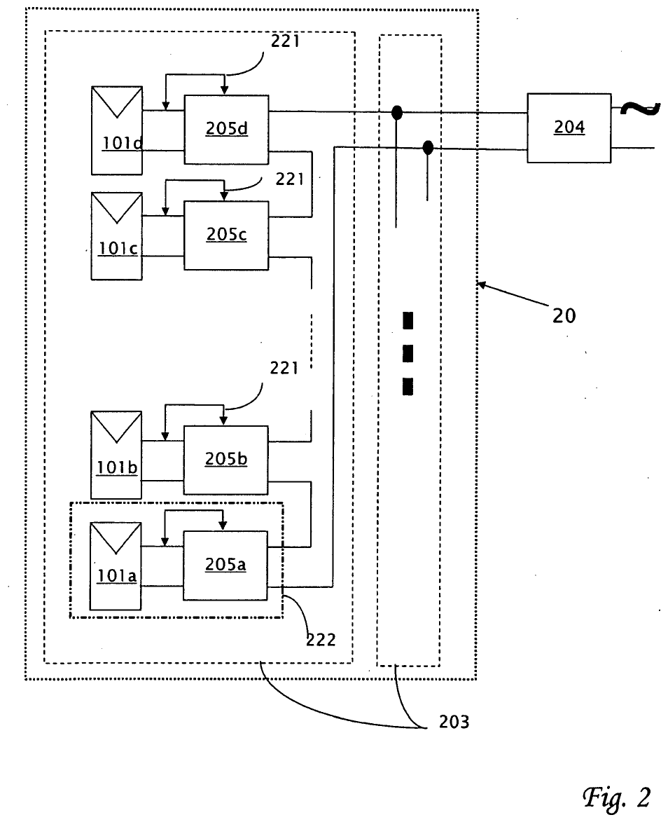

Reference is now made to FIG. 2 which illustrates a distributed power harvesting circuit 20, based on the disclosure in U.S. application Ser. No. 11/950,271. Circuit 20 enables connection of multiple distributed power sources, for example solar panels 101a-101d, to a single power supply. Series string 203 of solar panels 101 may be coupled to an inverter 204 or multiple connected strings 203 of solar panels 101 may be connected to a single inverter 204. In configuration 20, each solar panel 101a-101d is connected individually to a separate power converter circuit or a module 205a-205d. Each solar panel 101 together with its associated power converter circuit 205 forms a power source or power generating element 222. (Only one such power generating element 222 is marked in FIG. 2.) Each converter 205a-205d adapts optimally to the power characteristics of the connected solar panel 101a-101d and transfers the power efficiently from input to output of converter 205. Converters 205a-205d are typically microprocessor controlled switching converters, e.g. buck converters, boost converters, buck/boost converters, flyback or forward converters, etc. The converters 205a-205d may also contain a number of component converters, for example a serial connection of a buck and a boost converter. Each converter 205a-205d includes a control loop 221, e.g. MPPT loop that receives a feedback signal, not from the converter's output current or voltage, but rather from the converter's input coming from solar panel 101. The MPPT loop of converter 205 locks the input voltage and current from each solar panel 101a-101d at its optimal power point, by varying one or more duty cycles of the switching conversion typically by pulse width modulation (PWM) in such a way that maximum power is extracted from each attached panel 101a-101d. The controller of converter 205 dynamically tracks the maximum power point at the converter input. Feedback loop 221 is closed on the input power in order to track maximum input power rather than closing a feedback loop on the output voltage as performed by conventional DC-to-DC voltage converters.

As a result of having a separate MPPT circuit in each converter 205a-205d, and consequently for each solar panel 101a-101d, each string 203 may have a different number or different specification, size and/or model of panels 101a-101d connected in series. System 20 of FIG. 2 continuously performs MPPT on the output of each solar panel 101a-101d to react to changes in temperature, solar radiance, shading or other performance factors that affect one or more of solar panels 101a-101d. As a result, the MPPT circuit within the converters 205a-205d harvests the maximum possible power from each panel 101a-101d and transfers this power as output regardless of the parameters effecting other solar panels 101a-101d. The outputs of converters 205a-205d are series connected into a single DC output that forms the input to inverter 204. Inverter 204 converts the series connected DC output of converters 205a-205d into an AC power supply.

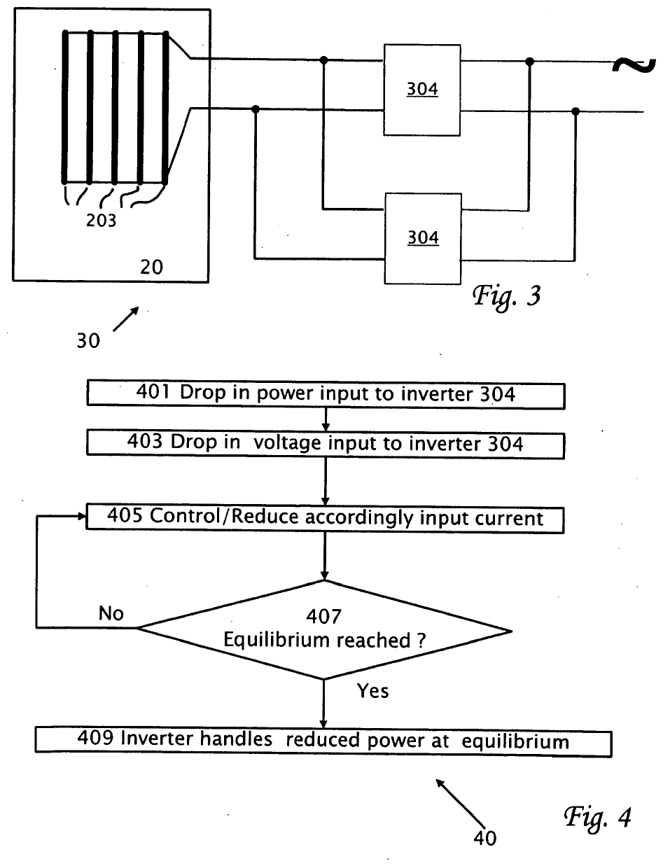

Reference is now made to FIG. 3 which illustrates a simplified system 30, according to an embodiment of the present invention. A solar panel array 20 in different embodiments may have serial and/or parallel power generating modules 222, each of which includes solar panel 101 and MPPT power converter 205. In system 30, five strings 203 are connected in parallel. Connected to solar panel array 20 are multiple, e.g. two inverters 304 which are parallel connected both at their inputs and their outputs.

Reference is now also made to FIG. 4, a simplified flow diagram illustrating a method 40, according to an embodiment of the present invention. Operation of system 30 is characterized by inverters 304 controlling their input currents based on the voltage input to inverters 304. Under these circumstances, a drop in power (step 401), for instance caused by a cloud moving in front of the sun causes a drop (step 403) in voltage input to inverter 304. The drop (step 403) in voltage input to inverters 304 causes inverters 304 to reduce (step 405) respective input currents which in turn tends to raise the input voltage respectively to inverters 304. An equilibrium is reached (decision box 407) as both inverters 304 handle reduced power (step 409) from solar panel array 20. This process is repeated continuously or intermittently to respond to changes in the operational characteristics of the DC power source.

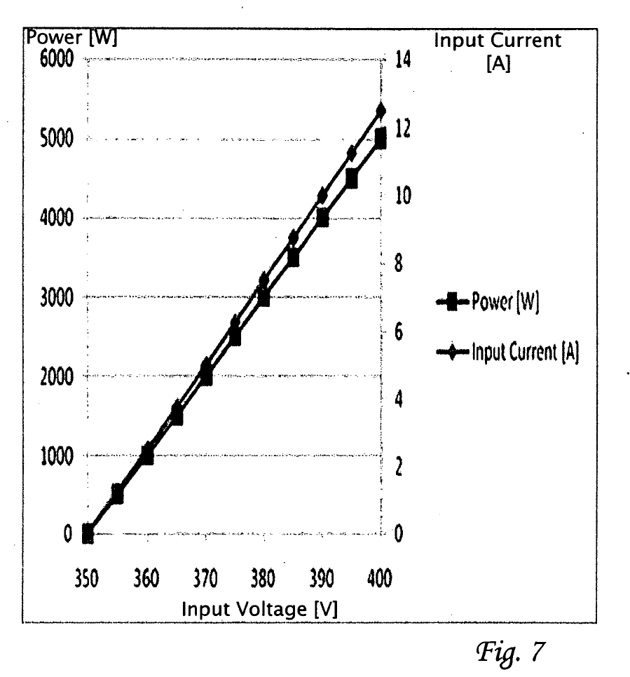

Referring back to FIG. 3, in an example of an embodiment of the present invention using solar panel array 20 includes five parallel connected strings 203, each string of ten power generating modules 222 each connected in series to parallel-connected inverters 304 which output a grid voltage of 220V RMS. Nominal input voltage to parallel-connected inverters 304 at maximum power conversion, e.g. 10 kiloWatts, is 400 Volts with 5 kiloWatts through each of two inverters 304. Hence, ignoring power conversion/inversion efficiency losses, each of fifty solar panels 101 output 200 Watt of electrical power at 40 Volts. Current through each string is 2000 W/400V=5 amperes. Power generating modules 222 are configured to maximize their power input (or power output from solar panels 101). Voltage output from power generating modules 222 is typically floating. If the power output from power generating modules 222 decreases (for instance as a result of solar shading, e.g., cloud) input power to inverters 304 drops (step 401). Inverters 304 are configured to adjust their current draw (step 405) based on input voltage. Reference is now made to FIG. 7 a graph showing a typical control current-voltage characteristic for controlling current response to input voltage, according to a feature of the present invention. In the example, the horizontal axis is Voltage in volts and the vertical axes indicate respectively and Power in Watts and Current in amperes. Of course, while in this example a linear function is shown for use by all inverters, other functions may be used and/or each individual inverter may have a different function. According to the graph, 5 kW inverters 304 are configured to draw close to zero Watts at 350 V_{DC} input, 2.5 kiloWatt at 375 V_{DC} input, and the full 5 kiloWatt at 400V_{DC} input. In this case, if the direct current power is 10 kiloWatt, each inverter 304 operates at full peak load with an input voltage of 400 V_{DC} (each inverter 304 drawing each 12.5 ampere, so that total current draft is 25 ampere=10 kilo Watt/400 Volt). If the power input to inverters 304 drops to, e.g., 5 kW total power, both inverters 304 experience a drop in the input voltage (since the DC input is now 5 kW, if inverters 304 keep on drawing 12.5 A each, then the voltage would be 200V). However, each inverter 304 starts reducing its input current until an equilibrium is reached (decision box 407), which in this case is with each inverter 304 drawing 6.25 ampere at 375 VDC input to a total of 2.5 kW power inverted by each inverter 304 and 5 kW for the total both inverters 304.

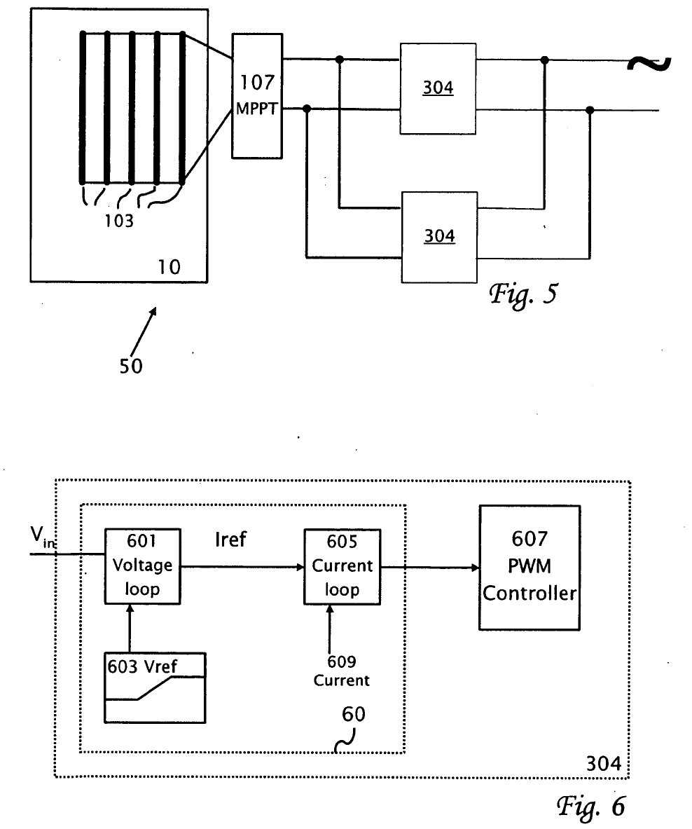

Reference is now made to FIG. 5 which illustrates a simplified system 50, according to an embodiment of the present invention. A solar panel array 10 in different embodiments may have serial and/or parallel connected solar cells/panels 101. An MPPT power circuit 107 maintains a maximum power output of solar panel array 10 typically by drawing current at the peak power output level of solar panel array 10. The output voltage of MPPT circuit 107 is preferably floating. Connected to MPPT 107 are multiple inverters, e.g. two inverters, 304 which are parallel connected both at their inputs and their outputs.

The operation of system 50 is illustrated by referring back to FIG. 4. If the power output from solar panel array 10 decreases (for instance as a result of solar shading, e.g., cloud) input power to inverters 304 drops (step 401). Inverters 304 are configured to adjust their current draw (step 405) based on input voltage. Each inverter 304 starts reducing (step 405) its input current until an equilibrium is reached (decision box 407) and each inverter 304 handles (step 409) a reduced power load.

Reference is now made to FIG. 6 which illustrates a simplified system diagram of inverter 304 with an integrated control module 60 according to an embodiment of the present invention. Control module 60 includes two control loops a voltage control loop 601 and a current control loop block 605. A previously specified voltage reference block 603 specifies two voltage references, a lower voltage reference and an upper voltage reference. As previously stated, in this example inverter 304 operates with a DC input voltage of 400V in order to invert to 220V RMS. Hence, in this specific example both the lower and upper voltage references are in the vicinity of 400 V DC. In the previous example used in reference to FIG. 3 the lower reference voltage is 350 VDC and the upper reference voltage is 400 VDC. Voltage control loop block 601 compares the actual input DC voltage to the voltage references and outputs a current reference I_{ref} signal. The current reference signal I_{ref} is used as an input to current control loop block 605. Current control loop block 605 receives also a signal 609 proportional to its output current. Typically, a current sensor provides signal 609 from within a pulse width modulation (PWM) block 607 of inverter 304, which performs the power inversion. Current control loop block 605 compares output current signal 609 with the current reference signal I_{ref} and adjusts the output current accordingly until the current (and output power) equilibrate. Thus, each inverter 304 typically handles an equal load of power from solar panel array 10 or 20.

As can be understood, in general, embodiments of the invention provide a system whereby a plurality of power converters, e.g., inverters, are connected in parallel and share the power conversion load according to a prescribed function, but each power converter autonomously determines its share of power conversion. That is, each power converter operates according to its own power conversion formula/function, such that overall the parallel-connected converters share the power conversion load in a predetermined manner. That is, while the power conversion sharing scheme is designed according to the system as a whole, i.e., division of duty to all of the converters, each individual inverter operates individually to draw power according to its own formula. In one specific case, e.g., where all of the converters are of the same model and same rating, the formula is the same for all of the converters. On the other hand, in other implementations the formula can be individually tailored to each converter. For example, in installation where one converter has double the conversion capacity as all the other converters in the system, its formula may dictate its power conversion share to be double as the other converters. Also, while the formula exemplified in FIG. 7 is linear, other functions or formulas may be used, as this is given as one particular example.

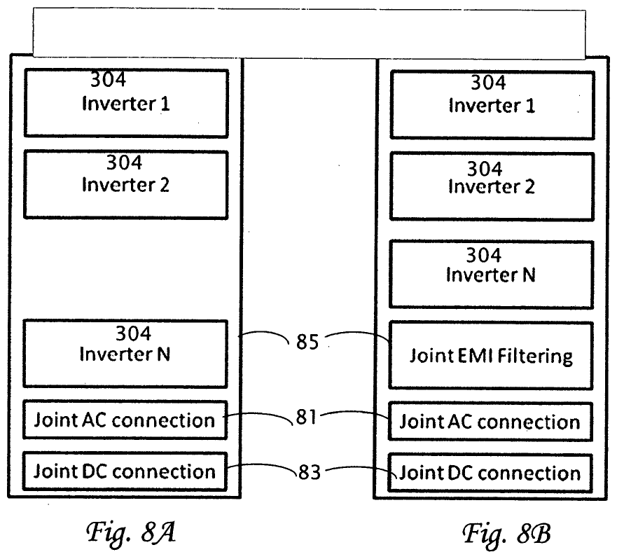

Reference is now made to FIGS. 8A and 8B which illustrate racks with parallel connected inverters, according to a feature of the present invention. In this embodiment some or all of inverters 304 may be configured for operating in a load-balancing mode, according to an embodiment of the present invention, but inverters 304 may actually share some components. One such embodiment might be parallel inverters 304 with a shared enclosure for the electrically separate inverters, as depicted in FIG. 8A. Other embodiments might also include shared electrical elements of the inverters, and example of which as depicted in FIG. 8B which shows parallel connected inverters with a shared EMI/RFI filter bank (these filters might be at the DC input, AC input, or both). Joint connections are shown in the racks, shared by inverters 304, a joint AC connection 81 to the grid and a joint DC connection 83 to DC power source 20. According to a further feature of the present invention, a joint electromagnetic interference filter is used to filter all the outputs of inverters 304 and electromagnetic radiation therefrom, whether they are actually load balancing or not, according to the present invention.

The articles “a”, “an”, as used hereinafter are intended to mean and be equivalent to “one or more” or “at least one”. For instance, “a direct current (DC) power source” means “one or more direct current (DC) power sources”. While the invention has been described with respect to a limited number of embodiments, it will be appreciated that many variations, modifications and other applications of the invention may be made.

The present invention has been described in relation to particular examples, which are intended in all respects to be illustrative rather than restrictive. Those skilled in the art will appreciate that many different combinations of hardware, software, and firmware will be suitable for practicing the present invention. Moreover, other implementations of the invention will be apparent to those skilled in the art from consideration of the specification and practice of the invention disclosed herein. Various aspects and/or components of the described embodiments may be used singly or in any combination in the server arts. It is intended that the specification and examples be considered as exemplary only, with a true scope and spirit of the invention being indicated by the following claims.

1. A power apparatus comprising:
a plurality of power converters within an enclosure, each power converter comprising an input and an output, wherein the inputs of the plurality of power converters are connected in parallel and configured to receive a direct current (DC) power, and the outputs of the plurality of power converters are connected in parallel to produce an alternating current (AC) power;
wherein each of the plurality of power converters comprises a controller, wherein the controller of a respective one of the plurality of power converters is configured to independently control current drawn by the respective one of the plurality of power converters responsive to a voltage of the DC power; and
wherein each of the plurality of power converters is configured to convert a different share of the DC power to produce the AC power.

2. The power apparatus of claim 1, wherein the controller is configured to maintain a maximum peak power at the respective input of the respective one of the plurality of power converters.

3. The power apparatus of claim 1, wherein the controller is configured to:
output a current reference signal based on a comparison of the voltage of the DC power to at least one previously specified reference voltage,
compare the current reference signal with a current signal proportional to a current from the DC power, and
adjust an output current based on the comparison between the current reference signal and the current signal proportional to the current from the DC power.

4. The power apparatus of claim 1, wherein each of the plurality of power converters comprises: (a) a DC to DC converter, (b) a DC to AC converter, or (c) a DC to DC converter and a DC to AC converter.

5. The power apparatus of claim 1, further comprising one or more electromagnetic interference (EMI) or radio frequency interference (RFI) filters coupled to the plurality of power converters.

6. A method comprising:
receiving, by a plurality of power converters housed within an enclosure, a direct current (DC) power, wherein each of the plurality of power converters comprises a respective DC input and a respective alternating current (AC) output; and
independently controlling, by one of a plurality of controllers, current drawn by a respective one of the plurality of power converters from the DC power; and
converting, by each of the plurality of power converters, a different share of the DC power to produce an AC power,
wherein the AC outputs of the plurality of power converters are connected in parallel.

7. The method of claim 6, further comprising maintaining maximum peak power at the DC inputs using the plurality of controllers.

8. The method of claim 6, further comprising:
outputting a current reference signal based on comparing a voltage at the DC inputs to at least one previously specified reference voltage;
comparing the current reference signal with a current signal proportional to a current from the DC power; and
adjusting an output current based on the comparison between the current reference signal and the current signal proportional to the current from the DC power.

9. A method comprising:
receiving, by a plurality of power converters housed in an enclosure, a direct current (DC) power, wherein the plurality of power converters comprises DC inputs connected in parallel for receiving the DC power;
independently controlling current drawn by each of the plurality of power converters from the DC power; and
maintaining, using a plurality of controllers, maximum peak power at the DC inputs,
wherein each of the plurality of power converters is configured to contribute a different share of the DC power to produce an alternating current (AC) power.

10. The method of claim 9, wherein the plurality of power converters comprises AC outputs connected in parallel.

11. The method of claim 9, further comprising:
outputting a current reference signal based on comparing a voltage at the DC inputs to at least one previously specified reference voltage;
comparing the current reference signal with a current signal proportional to a current from the DC power; and
adjusting an output current based on the comparison between the current reference signal and the current signal proportional to the current from the DC power.

12. A power device comprising:
a plurality of power converters within an enclosure, wherein each of the plurality of power converters comprises input terminals and output terminals, wherein the input terminals are coupled in parallel, and wherein the output terminals are coupled in parallel; and
wherein each of the plurality of power converters comprises a controller, the controller of a respective one of the plurality of power converters configured to independently vary an operation of a respective one of the plurality of power converters according to a respective direct current (DC) power input,
wherein each of the plurality of power converters is configured to draw a different share of the DC power from the respective DC power input.

13. The power device of claim 12, wherein each controller of the plurality of power converters is configured to vary a current drawn by the respective one of the plurality of power converters according to one of the respective DC power input or a DC voltage input.

14. The power device of claim 12, wherein each controller of the plurality of power converters is configured to vary a current drawn by the respective one of the plurality of power converters so as to maintain a linear functional relationship between an input current and an input voltage.

15. The power device of claim 14, wherein the linear functional relationship is the same for each controller.

16. The power device of claim 12, wherein each controller of the plurality of power converters is configured to maintain a maximum peak power at the input terminals.

17. The power device of claim 14, further comprising one or more electromagnetic interference (EMI) or radio frequency interference (RFI) filters coupled to the plurality of power converters.

18. A power system comprising:
a plurality of photovoltaic (PV) power sources; and
a power device comprising:
a plurality of power converters within an enclosure, wherein each of the plurality of power converters comprises input terminals and output terminals, wherein the input terminals are coupled in parallel to the plurality of PV power sources, and wherein the output terminals are coupled in parallel,
wherein each of the plurality of power converters is configured to draw a different share of power from the plurality of PV power sources, and
wherein the plurality of PV power sources each comprises a plurality of power generating elements coupled to provide a single direct current (DC) power output.

19. The power system of claim 18, further comprising a plurality of controllers, wherein each controller is coupled to one of the plurality of power converters, and each controller is configured to monitor the plurality of PV power sources and independently vary an operation of a respective one of the plurality of power converters according to a performance of the plurality of PV power sources.

20. The power system of claim 18, further comprising a plurality of maximum power point tracking (MPPT) circuits connected to the plurality of PV power sources, wherein each of the MPPT circuits is connected to one or more of the plurality of PV power sources.
